(19) United States
(12) Patent Application Publication
(10) Pub. No.: US 2021/0293085 A1
(43) Pub. Date: Sep. 23, 2021

(54) ENGAGING UNIT AND BLIND HAVING THE SAME

(71) Applicant: CHING FENG HOME FASHIONS CO., LTD., FUXING TOWNSHIP (TW)

(72) Inventor: Wei-Ming SHIH, FUXING TOWNSHIP (TW)

(73) Assignee: CHING FENG HOME FASHIONS CO., LTD., FUXING TOWNSHIP (TW)

(21) Appl. No.: 16/861,816

(22) Filed: Apr. 29, 2020

(30) Foreign Application Priority Data
Mar. 20, 2020 (TW) 109203252

(51) Int. Cl. E06B 9/323; E06B 9/322

(52) U.S. Cl. CPC E06B 9/323; E06B 9/322

(57) ABSTRACT

An engaging unit mounted on a head beam of a blind is provided. The engaging unit includes a spring holder, extension spring, sliding holder, pull cord and pull cord holder. Two ends of the extension spring are hooked to the spring holder and sliding holder, respectively. An engaging portion of the pull cord holder engages with the head beam. The pull cord has one end disposed at a cord fastening portion of the pull cord holder and the other end wound around a first cord-winding portion of the sliding holder and a second cord-winding portion of the pull cord holder by predetermined journeys. The sliding holder slides to and fro on the head beam in response to the pull cord's ascent and descent and the extension spring's extension and contraction. A blind with the engaging unit is further provided and includes a head beam, blind body and bottom beam.

### BACKGROUND OF THE INVENTION

### 1. Technical Field

The present disclosure relates to blinds and, more particularly, to an engaging unit fitted to a head beam of a blind.

### 2. Description of Related Art

Referring to FIG. 1 and FIG. 2, a conventional hidden-style pull-cord blind 90 comprises one head beam 91, one blind body 92, one bottom beam 93 and an engaging unit 95. The two ends of the blind body 92 are disposed between the head beam 91 and the bottom beam 93. The engaging unit 95 is fitted to the head beam 91.

Referring to the aforesaid diagrams, viewed from right to left, the engaging unit 95 comprises one spring fixing holder 951, one extension spring 952, one sliding holder 953 capable of sliding to and fro at the bottom of the head beam 91, a pull cord 954 and one pull cord fixing holder 955. The spring fixing holder 951 and the pull cord fixing holder 955 are fixed by one riveting element 94 each to two opposing ends of the bottom of the head beam 91, respectively. The pull cord 954 has one end disposed on the pull cord fixing holder 955 and the other end wound around the pull cord fixing holder 955 and the sliding holder 953 in accordance with a predetermined journey, then passed through the blind body 92 and cord holes 911 at the bottom of the head beam 91, and finally movably disposed between the blind body 92 and the bottom beam 93. The extension spring 952 has one end fastened to the spring fixing holder 951 by one screw and the other end fastened to the sliding holder 953 by one screw. Consequently, the extension spring 952 extends or contracts because of the sliding holder 953 sliding laterally to and fro at the bottom of the head beam 91. When the bottom beam 93 and the blind body 92 are pulled downward, the pull cord 954 of the engaging unit 95 drives the sliding holder 953 sliding toward the pull cord fixing holder 955. At this point in time, the extension spring 952 also extends until the bottom beam 93 and the blind body 92 are pulled downward to a predetermined position.

However, the assembly process entails fixing the spring fixing holder 951 and the pull cord fixing holder 955 of the engaging unit 95 to two opposing ends of the bottom of the head beam 91, respectively, by the riveting element 94 each, then winding the pull cord 954 around the pull cord fixing holder 955 and the sliding holder 953 in accordance with a predetermined journey, and finally fastening two ends of the extension spring 952 to the spring fixing holder 951 and the sliding holder 953 by screws, respectively. However, the assembly process entails exerting a downward force on the riveting elements 94. If the force is exerted inappropriately, the spring fixing holder 951 and the pull cord fixing holder 955 must be mounted on the bottom of the head beam 91 anew. As a result, not only is the assembly process inconvenient, but the assembly process also leads to a waste of material management and promotion cost. Therefore, the prior art has room for improvement.

### BRIEF SUMMARY OF THE INVENTION

It is an objective of the present disclosure to provide an engaging unit adapted to be mounted on a head beam of a blind, so as to not only effectively preclude a rework process which might otherwise be required due to inappropriate application of forces but also enhance assembly workers' assembly efficiency.

In order to achieve the above and other objectives, the engaging unit is adapted to be mounted on a bottom wall of a head beam of a blind and comprises a spring holder, an extension spring, a sliding holder, a pull cord and a pull cord holder. The spring holder has a hook portion. One end of the extension spring is hooked to the hook portion of the spring holder. The sliding holder has a hook portion and a first cord winding portion. The other end of the extension spring is hooked to the hook portion of the sliding holder. The pull cord holder has a cord fastening portion, an engaging portion and a second cord winding portion. The engaging portion is engaged with the bottom wall of the head beam. One end of the pull cord is disposed at the cord fastening portion. The other end of the pull cord is wound around the second cord winding portion of the pull cord holder and the first cord winding portion of the sliding holder in accordance with a predetermined journey. Therefore, the sliding holder slides to and fro on the bottom wall of the head beam in response to ascent and descent of the pull cord as well as extension and contraction of the extension spring.

The present disclosure further provides a blind comprising a head beam, a blind body, a bottom beam and a said engaging unit. The head beam has a bottom wall. Two cord holes and a fitting hole are penetratingly disposed on the bottom wall. One end of the blind body is fitted to the outer surface of the bottom wall of the head beam. The bottom beam is fitted to the other end of the blind body. The engaging unit is fitted to the bottom wall of the head beam. The engaging portion of the pull cord holder of the engaging unit is engagedly disposed in the fitting hole of the bottom wall of the head beam. The other end of the pull cord is wound around the second cord winding portion of the pull cord holder and the first cord winding portion of the sliding holder in accordance with a predetermined journey, then passed through the blind body and the two cord holes of the bottom wall of the head beam, and finally disposed at the bottom beam and opposite positions of the two cord holes of the bottom wall of the head beam. Therefore, the sliding holder slides to and fro on the bottom wall of the head beam in response to ascent and descent of the pull cord as well as extension and contraction of the extension spring.

Preferably, the bottom wall of the head beam of the blind further comprises another fitting hole spaced apart from the fitting hole, whereas the spring holder of the engaging unit further has an engaging portion engagedly disposed in the other fitting hole of the bottom wall of the head beam.

Fine structures, features, assembly or operation of an engaging unit and a blind having the same according to the present disclosure are illustrated by embodiments and described below. However, persons skilled in the art understand that the description below and the specific embodiments are illustrative of the present disclosure rather than restrictive of the claims of the present disclosure.

### BRIEF DESCRIPTION OF THE SEVERAL VIEWS OF THE DRAWINGS

FIG. 1 (PRIOR ART) is a perspective view of a conventional engaging unit operating in conjunction with a blind.

FIG. 2 is a top view based on FIG. 1.

FIG. 3 is a perspective view of an engaging unit operating in conjunction with a blind, with slats unfolded according to the first embodiment of the present disclosure.

FIG. 4 is a top view based on FIG. 3.

FIG. 5 is an exploded view based on FIG. 3.

FIG. 6 is a partial enlarged perspective view based on FIG. 3.

FIG. 7 is a perspective view of a pull cord holder of the engaging unit shown in FIG. 6.

FIG. 8 is an exploded view of another engaging unit and a blind, with slats unfolded, according to the second embodiment of the present disclosure.

FIG. 9 is a top view based on FIG. 8.

FIG. 10 is a perspective view of a spring holder of another engaging unit based on FIG. 8.

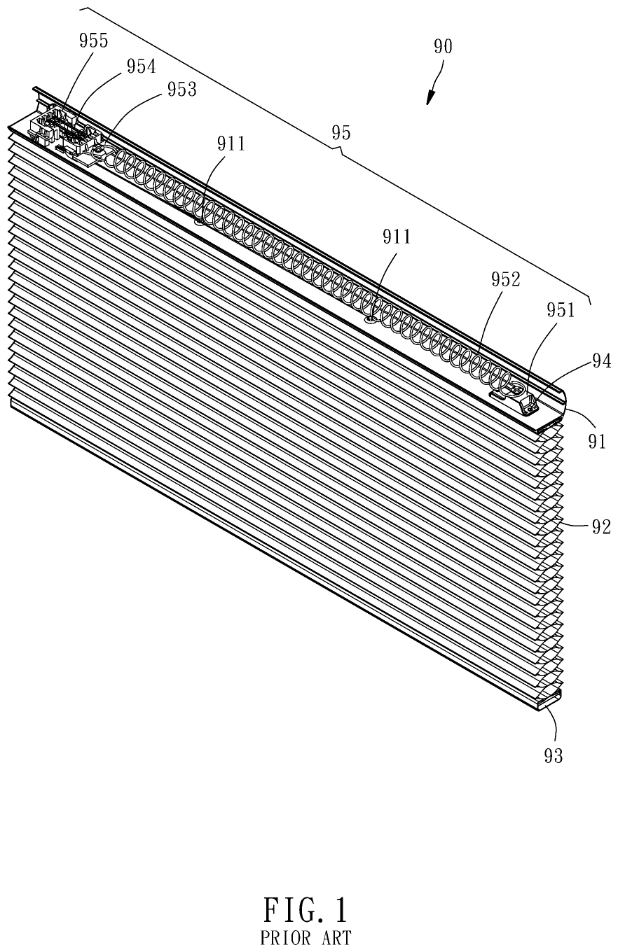

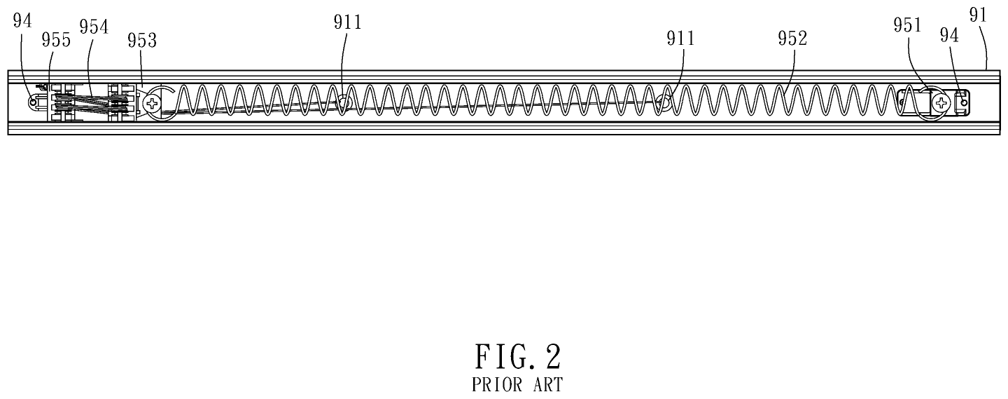

### DETAILED DESCRIPTION OF THE INVENTION

Directional expressions used herein, including the description of embodiments and claims, must be interpreted in accordance with the accompanying drawings. Identical reference numerals used in the embodiments and the accompanying drawings denote identical or similar components or structural features thereof.

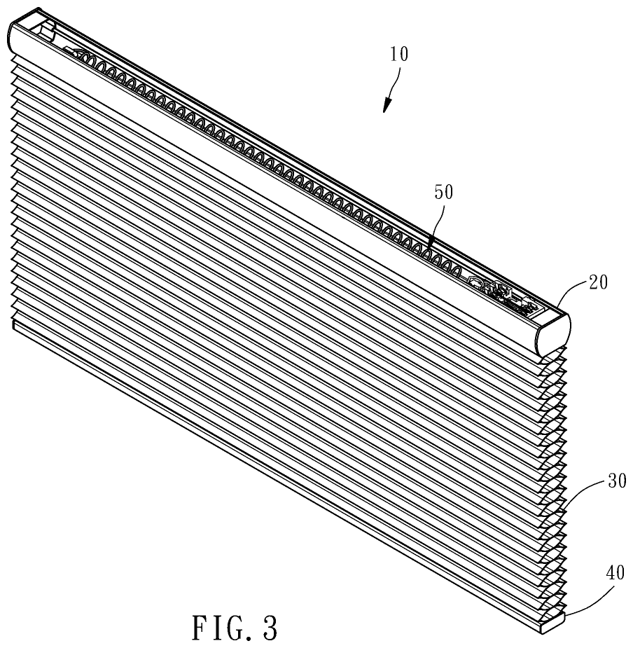

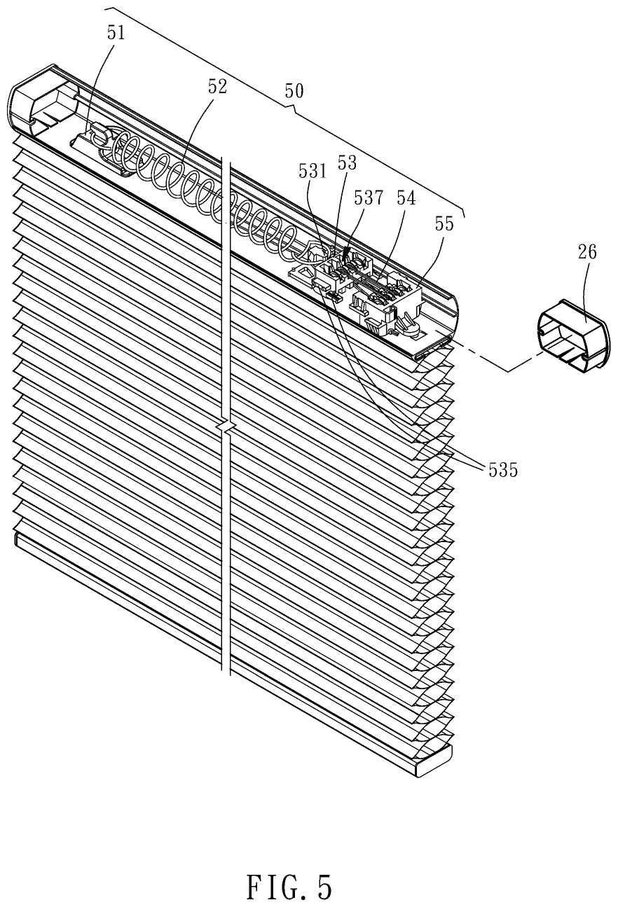

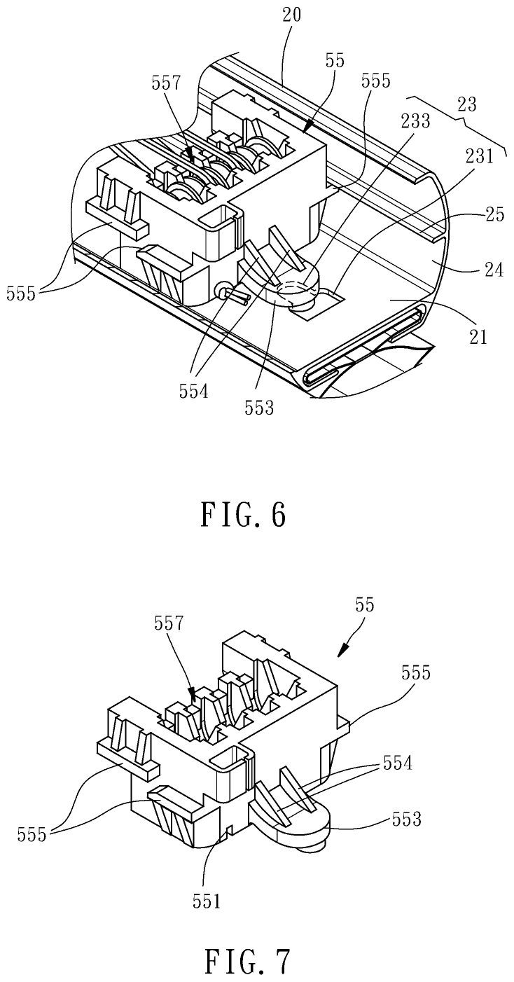

Referring to FIG. 3 through FIG. 7, the first embodiment of the present disclosure provides a hidden-style pull-cord blind 10 comprising one head beam 20, one blind body 30, one bottom beam 40 and an engaging unit 50.

The head beam 20 extends lengthwise, leftward and rightward, and has a substantially U-shaped transverse cross section. Two cord holes 22 and one fitting hole 23 are penetratingly disposed in the bottom wall 21 of the head beam 20. Two opposing lengthwise lateral sides of the bottom wall 21 of the head beam 20 extend upward to form two sidewalls 24. Parts of the inner walls of the two sidewalls 24 of the head beam 20 are substantially of the same height and protrude toward each other to form a guide rail 25. The head beam 20 has two opposing ends in its lengthwise direction, and the openings at the two ends are each covered with one cap 26. The cord holes 22 are in the number of one, three, four, five, six or more, depending on the length of the head beam 20 and the length of the blind body 30. The fitting hole 23 essentially comprises one major-hole portion 231 and one minor-hole portion 233 in communication with the major-hole portion 231. Preferably, the major-hole portion 231 of the fitting hole 23 is positioned proximate to the opening at one of the ends of the head beam 20. The minor-hole portion 233 of the fitting hole 23 is substantially a slotted hole.

Both the blind body 30 (which consists of honeycomb shades for exemplary purposes, but the present disclosure is not limited thereto) and the bottom beam 40 not only correspond in position to the head beam 20 but also extend lengthwise, leftward and rightward. The blind body 30 has two opposing ends in its lengthwise direction. One end of the blind body 30 is fitted to the outer surface of the bottom wall 21 of the head beam 20. The other end of the blind body 30 is fitted to the bottom beam 40.

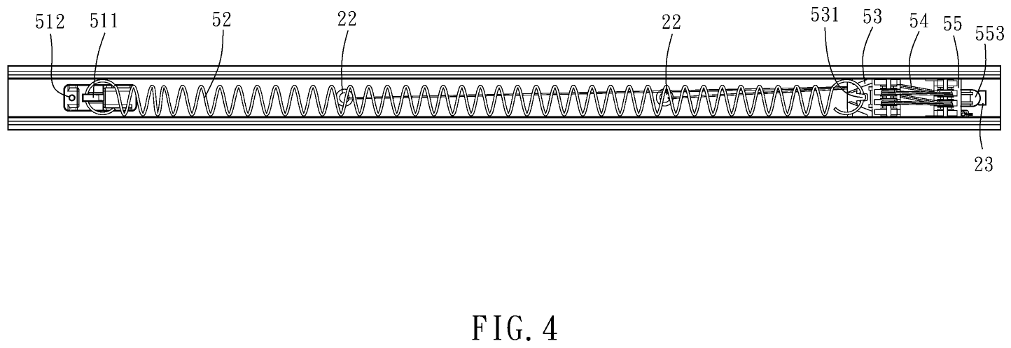

The engaging unit 50 is fitted to the bottom wall 21 of the head beam 20. Referring to FIG. 4 through FIG. 7, viewed from left to right, the engaging unit 50 comprises one spring holder 51, one extension spring 52, one sliding holder 53 capable of sliding to and fro at the bottom wall 21 of the head beam 20, a pull cord 54 and one pull cord holder 55.

The spring holder 51 has one hook portion 511.

The sliding holder 53 has one hook portion 531, two embedded portions 535 and one first cord winding portion 537. The two embedded portions 535 correspond in position to the two guide rails 25 of the head beam 20 and are embedded in the two guide rails 25 of the head beam 20, respectively, such that the sliding holder 53 slides to and fro on the bottom wall 21 of the head beam 20 more easily. Alternatively, it is sufficient for the sliding holder 53 to have only one embedded portion 535.

The pull cord holder 55 has one cord fastening portion 551, one engaging portion 553, two embedded portions 555 and one second cord winding portion 557. The cord fastening portion 551 is disposed at the bottom of the pull cord holder 55 and formed by denting the bottom of the pull cord holder 55 toward the body. The engaging portion 553 is one protruding wall positioned proximate to the cord fastening portion 551 and engagedly disposed in the fitting hole 23 of the bottom wall 21 of the head beam 20. Preferably, the outer diameter of the engaging portion 553 is less than or equal to the diameter of the major-hole portion 231 of the fitting hole 23 and corresponds to the diameter of the minor-hole portion 233 of the fitting hole 23. The engaging portion 553 is connected to the body of the pull cord holder 55 by two reinforcing ribs 554. The two embedded portions 555 correspond in position to the two guide rails 25 of the head beam 20 and are embedded in the two guide rails 25 of the head beam 20, respectively. In a variant embodiment, the pull cord holder 55 has only one embedded portion 555, and the engaging portion 553 is connected to the body of the pull cord holder 55 by one reinforcing rib 554 only.

Referring to FIG. 3, FIG. 5 through FIG. 7, fitting the engaging unit 50 and the elements thereof to the bottom wall 21 of the head beam 20 entails a user's fixing the spring holder 51 to the bottom wall 21 of the head beam 20 and the opening at the other end of the head beam 20 with one riveting element 512, such that the spring holder 51 is opposite the fitting hole 23. Preferably, the mouth of the hook portion 511 of the spring holder 51 faces the opening at the other end of the head beam 20. After that, the user embeds the two embedded portions 535 of the sliding holder 53 in the two guide rails 25 of the head beam 20, respectively, such that the sliding holder 53 slides to and fro at the bottom wall 21 of the head beam 20. Preferably, the mouth of the hook portion 531 of the sliding holder 53 faces the fitting hole 23 of the head beam 20. Then, the user embeds the two embedded portions 555 of the pull cord holder 55 in the two guide rails 25 of the head beam 20, respectively, such that one end of the engaging portion 553 (i.e., a protruding wall) of the pull cord holder 55 is penetratingly disposed in the major-hole portion 231 of the fitting hole 23 and then engagedly disposed in the minor-hole portion 233 of the fitting hole 23.

Next, the user fastens one end (for example, a cord head) of the pull cord 54 to the cord fastening portion 551 of the pull cord holder 55 and then winds the other end of the pull cord 54 on the second cord winding portion 557 of the pull cord holder 55 and the first cord winding portion 537 of the sliding holder 53 in accordance with predetermined journeys (four journeys in this embodiment for an exemplary purpose, but the present disclosure is not limited thereto), such that the other end of the pull cord 54 is penetratingly disposed in the two cord holes 22 of the bottom wall 21 of the head beam 20 and the blind body 30 and thus disposed at the bottom beam 40 and opposite positions of the two cord holes 22 of the bottom wall 21 of the head beam 20. After that, the user hooks one end of the extension spring 52 to the hook portion 511 of the spring holder 51 and the other end of the extension spring 52 to the hook portion 531 of the sliding holder 53, such that the sliding holder 53 slides to and fro on the bottom wall 21 of the head beam 20 in response to extension and contraction of the extension spring 52. Finally, the user covers the openings at the two ends of the head beam 20 with the two caps 26, respectively. Therefore, the assembly process of the hidden-style pull-cord blind 10 disclosed in the first embodiment of the present disclosure is described above. The technical advantages of the present disclosure are described below.

First, the engaging portion 553 of the pull cord holder 55 of the engaging unit 50 is engagedly disposed in the fitting hole 23 of the bottom wall 21 of the head beam 20. Therefore, compared with conventional assembly processes, the present disclosure not only effectively precludes a rework process which might otherwise be required due to inappropriate application of forces but also enhances assembly workers' assembly efficiency.

Second, the two embedded portions 535 of the sliding holder 53 of the engaging unit 50 and the two embedded portions 555 of the pull cord holder 55 are embedded in the two guide rails 25 of the head beam 20, respectively, such that not only does the sliding holder 53 slide to and fro on the bottom wall 21 of the head beam 20 more easily, but the pull cord holder 55 is also fitted to the head beam 20 easily.

Third, the two ends of the extension spring 52 of the engaging unit 50 are hooked to the hook portion 511 of the spring holder 51 and the hook portion 531 of the sliding holder 53, respectively. Therefore, unlike conventional assembly processes, the present disclosure not only effectively precludes a rework process which might otherwise be required due to inappropriate application of forces but also enhances assembly workers' assembly efficiency.

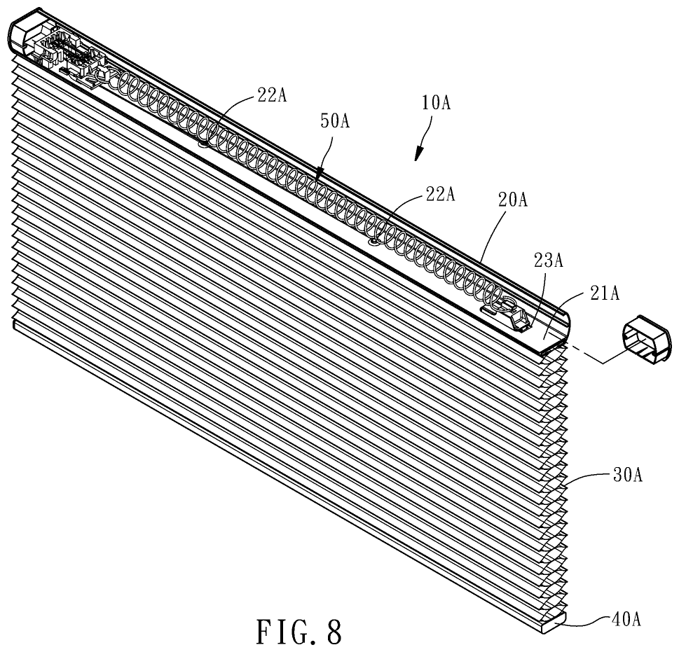

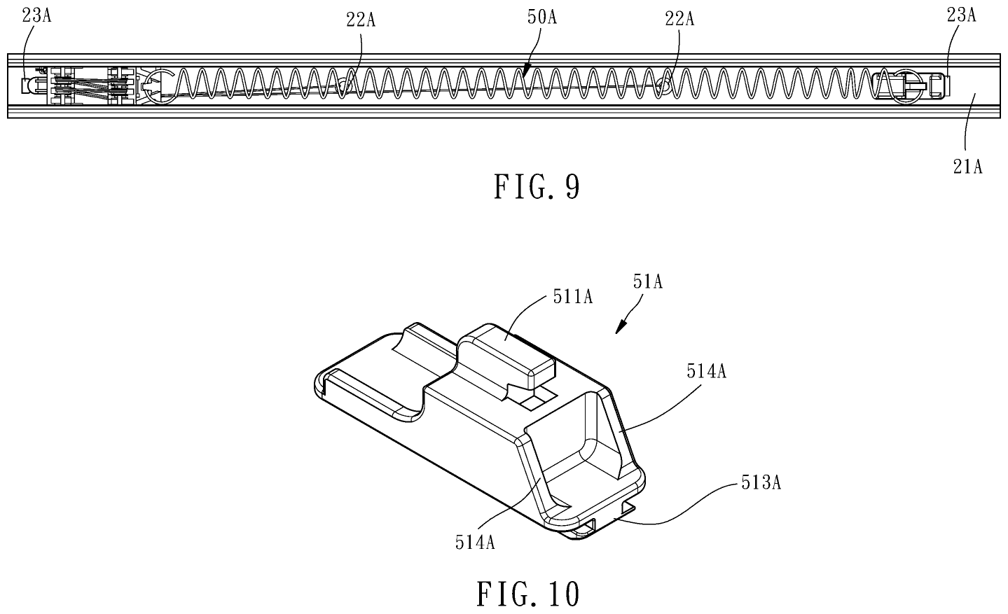

Referring to FIG. 8 through FIG. 10, the second embodiment of the present disclosure provides another hidden-style pull-cord blind 10A which comprises one head beam 20A, one blind body 30A, one bottom beam 40A and an engaging unit 50A. The connection relationships between technical features and the intended technical advantages thereof disclosed in the second embodiment are substantially the same as those disclosed in the first embodiment and thus are, for the sake of brevity, not described again. The technical features which distinguish the second embodiment from the first embodiment are described below.

Two cord holes 22A and two fitting holes 23A are penetratingly disposed in the bottom wall 21A of the head beam 20A. The two fitting holes 23A are positioned proximate to the openings at two opposing ends of the bottom wall 21A of the head beam 20A, respectively. The two opposing ends of the bottom wall 21A of the head beam 20A lie in the lengthwise direction of the bottom wall 21A of the head beam 20A. Likewise, the cord holes 22A are in the number of one, three, four, five, six or more, depending on the length of the head beam 20A and the length of the blind body 30A. Any one of the fitting holes 23A essentially consists of one major-hole portion and one minor-hole portion in communication with the major-hole portion. Preferably, the major-hole portion of any one of the fitting holes 23A is positioned proximate to the opening at one of the two ends of the head beam 20A, whereas the minor-hole portion of any one of the fitting holes 23A is substantially a slotted hole.

The spring holder 51A of the engaging unit 50A has one hook portion 511A and one engaging portion 513A, such that the mouth of the hook portion 511A of the spring holder 51A faces any one of the fitting holes 23A of the head beam 20A. The engaging portion 513A of the spring holder 51A is one protruding wall engagedly disposed in one of the fitting holes 23A of the bottom wall 21A of the head beam 20A. Preferably, the outer diameter of the engaging portion 513A of the spring holder 51A is less than or equal to the diameter of the major-hole portion of any one of the fitting holes 23A of the head beam 20A and corresponds to the diameter of the minor-hole portion of any one of the fitting holes 23A. The engaging portion 513A of the spring holder 51A is connected to the body of the spring holder 51A by two reinforcing ribs 514A and faces the direction in which the mouth of the hook portion 511A opens.

What is claimed is:

1. An engaging unit, adapted to be mounted on a bottom wall of a head beam of a blind, the engaging unit comprising:
a spring holder having a hook portion;
an extension spring with an end hooked to the hook portion of the spring holder;
a sliding holder having a hook portion and a first cord winding portion, wherein another end of the extension spring is hooked to the hook portion of the sliding holder;
a pull cord; and
a pull cord holder having a cord fastening portion, an engaging portion and a second cord winding portion, the engaging portion being engaged with the bottom wall of the head beam, wherein the pull cord has an end disposed at the cord fastening portion and another end wound around the second cord winding portion of the pull cord holder and the first cord winding portion of the sliding holder in accordance with a predetermined journey, such that the sliding holder slides to and fro on the bottom wall of the head beam in response to ascent and descent of the pull cord as well as extension and contraction of the extension spring.

2. The engaging unit of claim 1, wherein the sliding holder has at least one embedded portion.

3. The engaging unit of claim 2, wherein the pull cord holder has at least one embedded portion.

4. The engaging unit of claim 3, wherein the engaging portion is connected to the body of the pull cord holder by at least one reinforcing rib.

5. The engaging unit of claim 1, wherein the engaging portion is connected to the body of the pull cord holder by at least one reinforcing rib.

6. The engaging unit of claim 2, wherein the engaging portion is connected to the body of the pull cord holder by at least one reinforcing rib.

7. A blind, comprising:
a head beam having a bottom wall, wherein two cord holes and a fitting hole are penetratingly disposed in the bottom wall;
a blind body with an end fitted to an outer surface of the bottom wall of the head beam;
a bottom beam fitted to another end of the blind body; and
a said engaging unit of claim 1, the engaging unit being fitted to the bottom wall of the head beam, thereby allowing the engaging portion of the pull cord holder of the engaging unit to be engagedly disposed in the fitting hole of the bottom wall of the head beam, wherein another end of the pull cord is wound around the second cord winding portion of the pull cord holder and the first cord winding portion of the sliding holder in accordance with a predetermined journey, then penetratingly disposed in the two cord holes of the bottom wall of the head beam and the blind body, and finally disposed at the bottom beam and opposite positions of the two cord holes of the bottom wall of the head beam, such that the sliding holder slides to and fro on the bottom wall of the head beam in response to ascent and descent of the pull cord as well as extension and contraction of the extension spring.

8. The blind of claim 7, wherein two opposing lengthwise sides of the bottom wall of the head beam extend upward to form two sidewalls, and the inner walls of the two sidewalls protrude toward each other to form a guide rail, wherein the sliding holder of the engaging unit has at least one embedded portion corresponding in position to and embedded in the guide rail of the head beam.

9. The blind of claim 8, wherein the pull cord holder of the engaging unit has at least one embedded portion corresponding in position to and embedded in the guide rail of the head beam.

10. The blind of claim 9, wherein the fitting hole of the head beam has a major-hole portion and a minor-hole portion in communication with the major-hole portion, wherein the engaging portion of the pull cord holder of the engaging unit is a protruding wall penetratingly disposed in the major-hole portion of the fitting hole of the head beam and then engagedly disposed in the minor-hole portion of the fitting hole.

11. The blind of claim 8, wherein the fitting hole of the head beam has a major-hole portion and a minor-hole portion in communication with the major-hole portion, wherein the engaging portion of the pull cord holder of the engaging unit is a protruding wall penetratingly disposed in the major-hole portion of the fitting hole of the head beam and then engagedly disposed in the minor-hole portion of the fitting hole.

12. The blind of claim 11, wherein the bottom wall of the head beam further comprises a fitting hole spaced apart from the fitting hole, and the spring holder of the engaging unit further has an engaging portion engagedly disposed in the fitting hole of the bottom wall of the head beam.

13. The blind of claim 7, wherein the bottom wall of the head beam further comprises a fitting hole spaced apart from the fitting hole, and the spring holder of the engaging unit further has an engaging portion engagedly disposed in the fitting hole of the bottom wall of the head beam.

14. The blind of claim 8, wherein the bottom wall of the head beam further comprises a fitting hole spaced apart from the fitting hole, and the spring holder of the engaging unit further has an engaging portion engagedly disposed in the fitting hole of the bottom wall of the head beam.

15. The blind of claim 9, wherein the bottom wall of the head beam further comprises a fitting hole spaced apart from the fitting hole, and the spring holder of the engaging unit further has an engaging portion engagedly disposed in the fitting hole of the bottom wall of the head beam.

16. The blind of claim 10, wherein the bottom wall of the head beam further comprises a fitting hole spaced apart from the fitting hole, and the spring holder of the engaging unit further has an engaging portion engagedly disposed in the fitting hole of the bottom wall of the head beam.
